(19) United States
(12) Patent Application Publication
(10) Pub. No.: US 2025/0149802 A1
(43) Pub. Date: May 8, 2025

(54) ANTENNA ARRAY WITH LARGE INTER-ELEMENT SPACING

(71) Applicant: HUAWEI TECHNOLOGIES CO., LTD., Shenzhen (CN)

(72) Inventors: Juan SEGADOR ALVAREZ, Munich (DE); Alejandro MURILLO BARRERA, Munich (DE); Zhi GONG, Dongguan (CN); Bruno BISCONTINI, Munich (DE); Francesco CAMINITA, Siena (IT); Giuseppe LABATE, Siena (IT); Massimo NANNETTI, Siena (IT); Cristian DELLA GIOVAMPAOLA, Siena (IT)

(21) Appl. No.: 19/014,524

(22) Filed: Jan. 9, 2025

Related U.S. Application Data
(63) Continuation of application No. PCT/EP2022/070195, filed on Jul. 19, 2022.

(51) Int. Cl. H01Q 21/06; H01Q 3/30; H01Q 19/10; H01Q 21/26

(52) U.S. Cl. CPC H01Q 21/06; H01Q 3/30; H01Q 19/10; H01Q 21/26

(57) ABSTRACT

An example antenna structure comprises a plurality of radiators arranged with space between one another. A distance between adjacent radiators of at least some of the plurality of radiators is greater than one wavelength of a highest frequency of an operating band of the antenna structure. A reflector is disposed beneath the plurality of radiators, and a metasurface structure is disposed above the plurality of radiators.

### CROSS-REFERENCE TO RELATED APPLICATIONS

This application is a continuation of International Application No. PCT/EP2022/070195, filed on Jul. 19, 2022, the disclosure of which is hereby incorporated by reference in its entirety.

### TECHNICAL FIELD

The present disclosure relates generally to an antenna structure and to a metasurface structure.

### BACKGROUND

With the deployment of 5G, in order to support the new bands 700M and 3.5G, there is a growing demand to develop antennas with an increased number of bands—for example, 700M/800M/900M/1.4G/1.8G/2.1G/2.6G/3.5G all together. In addition, to fully exploit the capabilities of the New Radio standard, the number of TRX/antenna ports and arrays/antenna columns per each band must also be increased.

Despite the increased number of bands and ports per band, the limitation of one antenna per sector (or a maximum of two in exceptional cases) remains a very strict requirement. In addition, to facilitate the site deployment and/or to be able to reuse the existing mechanical structures present at the sites, the dimensions and the wind load of the new antennas should be comparable to legacy products.

As such, it is desirable to enable the integration of several bands together in a neat manner, without affecting the size of the antenna. One approach to do so is to use arrays with large inter-element spacing (i.e. greater than one wavelength), thus reducing the number of radiators per array. As such, more bands can be integrated into the antenna.

The total field radiated as well as the directivity of an antenna depends largely on the elemental parameters, such as inter-element spacing. As the inter-element spacing increases, sidelobes emerge in the array radiation pattern. For example, when the spacing is increased to one wavelength, the sidelobes may become as big as the main lobe. These can significantly reduce the antenna gain and create interference. For uniformly spaced antenna arrays, the sidelobes can be eliminated by decreasing the separation between the elements. For non-uniform arrays, the sidelobes are much more difficult to predict.

### SUMMARY

An objective of the present disclosure is to provide an antenna structure having a large inter-element spacing.

The foregoing and other objectives are achieved by the features of the independent claims.

Further implementation forms are apparent from the dependent claims, the description and the Figures.

A first aspect of the present disclosure provides an antenna structure comprising a plurality of radiators provided in spaced relation to one another, wherein a distance between adjacent radiators of at least some of the plurality of radiators is greater than one wavelength of a highest frequency of an operating band of the antenna, a reflector disposed beneath the plurality of radiators, and a metasurface structure disposed above the plurality of radiators.

Accordingly, the spacing between radiators can be increased, without compromising performance. By increasing the inter-element spacing, the number of radiators can be reduced, the number of outputs of phase shifters can be reduced, manufacturing costs can be minimised, the integration of multiple frequency bands can be simplified and the interference between bands can be reduced by having less populated antennas.

In an implementation of the first aspect, the plurality of radiators may comprise a sequence of radiators arranged in a first direction and the metasurface structure may comprise a plurality of sections arranged in the first direction, each section having a respective value of impedance. Thus, the phase of the electric field can be flattened, thereby reducing grating lobes associated with the increased inter-element spacing and improving performance of the antenna structure by, inter alia, reducing interference caused by said grating lobes.

The plurality of sections may define a repeating pattern of impedance values. Thus, the repeating pattern can define, in the first direction, a periodic variation of impedance for the plurality of sections.

The repeating pattern may repeat with a period that is the same as the distance between adjacent radiators, or that is an integer multiple of the distance between adjacent radiators.

The metasurface structure may comprise multiple layers. Thus, enhanced control of the reflection and transmission phase can be achieved.

Each of the multiple layers may have a respective value of impedance. Thus, the reflection introduced by the metasurface can be minimized, and the phase of the transmission can be adjusted according to the requirements.

Each of the multiple layers may be disposed in spaced relation to one another.

The impedance of at least one of the sections may vary in a second direction orthogonal to the first direction.

The metasurface structure may comprise a substrate with a conductive pattern disposed thereon. Thus, impedance of the metasurface structure can be modified in a simple, cost-effective manner.

The metasurface structure may further comprise a layer disposed over the conductive pattern and the substrate.

Each of the plurality of radiators may be a dual polarity radiator.

The antenna structure may further comprise a second plurality of radiators provided in spaced relation to one another between the plurality of radiators.

A second aspect of the disclosure provides a metasurface structure for modifying the phase of electric fields of radiating elements of an antenna structure, the metasurface structure comprising a plurality of sections that defines a repeating pattern of impedance values, the repeating pattern comprising multiple sections, each section having a respective value of impedance.

Accordingly, the spacing between radiators can be increased, without compromising performance. By increasing the inter-element spacing, the number of radiators can be reduced, the number of outputs of phase shifters can be reduced, manufacturing costs can be minimised, the integration of multiple frequency bands can be simplified and the interference between bands can be reduced by having less populated antennas.

The repeating pattern may repeat with a period that is the same as the distance between adjacent radiators, or that is an integer multiple of the distance between adjacent radiators.

The plurality of sections may extend along a first direction and the respective value of impedance of a section may vary along a second direction orthogonal to the first direction.

A magnitude of an imaginary part of an impedance of the metasurface structure may be lower in an operating band than it is outside the operating band.

### BRIEF DESCRIPTION OF THE FIGURES

Embodiments will now be described by way of example always with reference to the figures, in which:

FIG. 1 schematically depicts a side view of an antenna structure, in accordance with an example embodiment;

FIG. 2 schematically depicts a top view of an antenna structure, in accordance with an example embodiment;

FIG. 3 schematically depicts a metasurface structure, in accordance with an example embodiment;

FIG. 4 schematically depicts electric field phase flattening effect, in accordance with an example embodiment; and

FIG. 5 schematically depicts metasurface impedance for multiple bands.

### DETAILED DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

Antennas exhibit a specific radiation pattern. The overall radiation pattern changes when several antenna elements are combined in an array. Side lobes are the lobes of the far field radiation pattern that are not the main beam. The number of side lobes increases with the number of elements. The main drawback of having inter-element spacings greater than one wavelength of the highest frequency of an operating band of the antenna is the emergence of high sidelobes in the array radiation pattern. These sidelobes are known as grating lobes and can significantly reduce the antenna gain and create interference. The grating lobes emerge due to discontinuities in the phase of the electric field along the direction of the extension of the antenna array.

According to an example, there is provided an antenna structure and a method for increasing an inter-element spacing in an antenna structure, such that the phase of electric fields of the radiators can be modified, reducing the far field radiation patterns in a compact, size-constrained antenna structure.

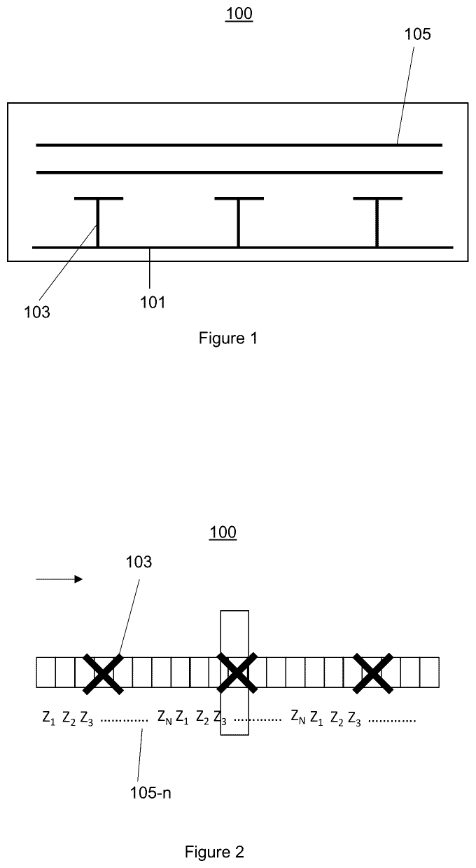

FIG. 1 schematically depicts a side view of an antenna structure, in accordance with an example embodiment. The antenna structure 100 comprises a plurality of radiators 103 provided in spaced relation to one another. The antenna 100 comprises a reflector 101 disposed beneath the plurality of radiators 103. The distance between adjacent radiators 103 of at least some of the plurality of radiators 103 is greater than one wavelength of a highest frequency of an operating band of the antenna structure 100. The operating band of the antenna refers to the range of frequencies that the antenna is capable of operating on with an acceptable level of efficiency. Quite often an antenna is capable of operating outside the set range, but its gain, voltage standing wave ratio (VSWR), and radiation patterns may be volatile or non-constant. The spacing between at least some of the radiators 103 is greater than one lambda of the highest frequency (i.e. the upper limit) of the operating band, as depicted in the figure.

The antenna structure 100 further comprises a metasurface structure 105. The metasurface structure is disposed above the plurality of radiators 103. The metasurface structure 105 may comprise an electromagnetic metasurface, i.e. an artificial sheet material with sub-wavelength thickness, capable of manipulating electromagnetic waves.

The purpose of the metasurface structure 105 is to mitigate the negative effects stemming from the increased spacing between the plurality of radiators 103, which normally causes grating lobes to appear in the radiation pattern, thereby reducing the antenna gain and creating interference. In particular, these grating lobes appear due to the discontinuities in the phase of the electric field along the direction of the extension of the antenna array. By introducing the metasurface structure 105, the phase profile of the electric field can be flattened, as illustrated in FIG. 4.

FIG. 2 schematically depicts a top view of the antenna structure 100, in accordance with an example embodiment. The plurality of radiators 103 may comprise a sequence of radiators arranged in a first direction (depicted by an arrow). The metasurface structure 105 may comprise a plurality of sections 105-1, 105-2, . . . , 105-n arranged in the first direction, each section 105-n having a respective value of impedance ZN. The respective value of impedance ZN may differ between adjacent sections, but the disclosure is not limited thereto. That is, each section 105-n may have a respective value of impedance ZN different from the respective value of impedance ZN of other sections of the plurality of sections 105-n.

The plurality of sections 105-n may define a repeating pattern of impedance values. The repeating pattern may thus define, in the first direction, a periodic variation in impedance for the plurality of sections 105-n. For example, the metasurface structure 105 may be divided into multiple sections with different impedance each, repeating according to a predefined period. By varying the impedance ZN of the individual sections 105-n, a different phase shift is introduced to the electric field, enabling reshaping of the phase curve. This may be achieved by calculating the required delay and the impedances needed to achieve flattening the curve. Referring back to FIG. 4, an input phase (below the metasurface structure 105) is denoted as 401, and an output phase (above the metasurface structure 105) is denoted as 402.

The impedance of at least one section of the plurality of sections 105-n may vary in a second direction orthogonal to the first direction. The repeating pattern may repeat with a period that is the same as the distance between adjacent radiators 103, or that is an integer multiple of the distance between adjacent radiators 103.

The metasurface structure 105 may comprise multiple layers. In the example of FIG. 1, the metasurface structure 105 comprises two layers, but the disclosure is not limited thereto. Increasing the number of layers of the metasurface structure 105 enables enhanced control of the reflection and transmission phase. In an embodiment, the metasurface structure 105 may comprise two or three layers.

Each of the multiple layers may have a respective value of impedance. Each of the multiple layers may be disposed in spaced relation to one another. In particular, by changing the impedance of each of the layers of the metasurface structure 105, the reflection introduced by the metasurface structure 105 can be minimized, allowing for adjustment of the phase of the transmission as desired.

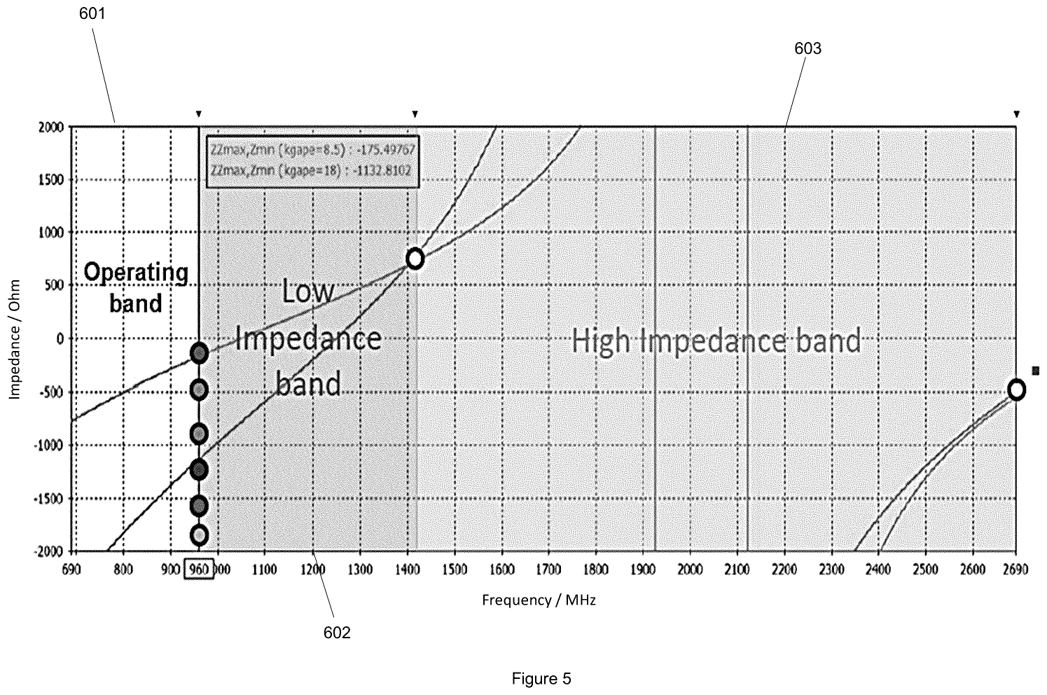

FIG. 5 schematically depicts metasurface impedance for multiple bands. Since the metasurface structure 105 is intended for utilization in a multiband environment, the metasurface structure 105 may be designed such that it is quasi-transparent to other frequency band radiators coexisting in the antenna structure 100. In order to achieve this, the respective value of impedance ZN should be relatively low in the operating band 601 and very high in the rest of the bands.

For example, the respective values may be such that the frequencies where the impedance of the metasurface structure 105 crosses the 0 Ohm line (low impedance band 602) are out of the working bands, as this would mean that the metasurface structure 105 operates like a reflector, ruining performance in that particular frequency. High impedance band 603 represents an area where the equivalent impedance of the metasurface structure 105 is very high, behaving like an open circuit and being quasi-transparent. Arrays working in this frequency can coexist in the same antenna structure 100 without any issues as the metasurface structure 105 has a small effect on such frequency band.

The metasurface structure 105 may comprise a substrate with a conductive pattern disposed thereon. The metasurface structure 105 may further comprise a layer disposed over the conductive pattern and the substrate. This enables the impedance of the metasurface structure 105 to be varied.

Each of the plurality of radiators 103 may be a dual polarity radiator. The antenna structure 100 may comprise a second plurality of radiators provided in spaced relation to one another between the plurality of radiators 103.

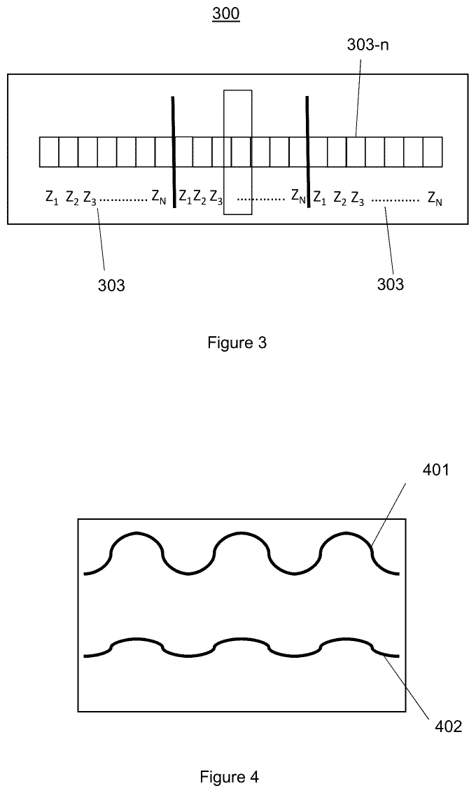

FIG. 3 schematically depicts a metasurface structure, in accordance with an example embodiment. The metasurface structure 300 shown in FIG. 3 may correspond to the metasurface structure 105 shown in FIGS. 1 and 2. The metasurface surface 300 for modifying the phase of electric fields of radiating elements of an antenna structure comprises a plurality of sections 303 that defines a repeating pattern of impedance values, the repeating pattern comprising multiple sections 303-n, each section 303-n having a respective value of impedance ZN. In an example, the impedance of a section can vary across the width of the unit cell. The repeating pattern may repeat with a period that is the same as the distance between adjacent radiators, or that is an integer multiple of the distance between adjacent radiators. The plurality of sections 303 may extend along a first direction and the respective value of impedance of a section may vary along a second direction orthogonal to the first direction. A magnitude of an imaginary part of an impedance of the metasurface structure 300 may be lower in an operating band of the antenna structure that the metasurface structure 300 is comprised in than it is outside the operating band.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

1. An antenna structure, comprising:
a plurality of radiators arranged with space between one another, wherein a distance between adjacent radiators of at least some of the plurality of radiators is greater than one wavelength of a highest frequency of an operating band of the antenna structure;
a reflector disposed beneath the plurality of radiators; and
a metasurface structure disposed above the plurality of radiators.

2. The antenna structure of claim 1, wherein the plurality of radiators comprise radiators sequentially arranged in a first direction, and wherein the metasurface structure comprises a plurality of sections arranged in the first direction, each of the plurality of sections having a respective value of impedance.

3. The antenna structure of claim 2, wherein the plurality of sections define a repeating pattern of impedance values.

4. The antenna structure of claim 3, wherein the repeating pattern repeats with a period that is the same as the distance between adjacent radiators, or the repeating pattern repeats with a period that is an integer multiple of the distance between adjacent radiators.

5. The antenna structure of claim 1, wherein the metasurface structure comprises a plurality of layers.

6. The antenna structure of claim 5, wherein each of the plurality of layers has a respective value of impedance.

7. The antenna structure of claim 5, wherein each of the plurality of layers is arranged with space between one another.

8. The antenna structure of claim 2, wherein an impedance of at least one of the sections varies in a second direction orthogonal to the first direction.

9. The antenna structure of claim 1, wherein the metasurface structure comprises a substrate with a conductive pattern disposed on the substrate.

10. The antenna structure of claim 9, wherein the metasurface structure further comprises a layer disposed over the conductive pattern and the substrate.

11. The antenna structure of claim 1, wherein each of the plurality of radiators is a dual polarity radiator.

12. The antenna structure of claim 1, further comprising a second plurality of radiators arranged with space between one another between the plurality of radiators.

13. A metasurface structure for modifying a phase of electric fields of radiating elements of an antenna structure, the metasurface structure comprising:
a plurality of sections that define a repeating pattern of impedance values, the repeating pattern comprising a plurality of sections, and each of the plurality of sections having a respective value of impedance.

14. The metasurface structure of claim 13, wherein the repeating pattern repeats with a period that is the same as a distance between adjacent radiators of the antenna structure, or the repeating pattern repeats with a period that is an integer multiple of the distance between adjacent radiators.

15. The metasurface structure of claim 13, wherein the plurality of sections extend along a first direction, and wherein the respective value of impedance of a section varies along a second direction orthogonal to the first direction.

16. The metasurface structure of claim 13, wherein a magnitude of an imaginary part of an impedance of the metasurface structure is lower in an operating band compared to outside the operating band.

17. The metasurface structure of claim 13, wherein the metasurface structure comprises a plurality of layers.

18. The metasurface structure of claim 17, wherein each of the plurality of layers has a respective value of impedance.

19. The metasurface structure of claim 17, wherein each of the plurality of layers is arranged with space between one another.

20. The metasurface structure of claim 13, wherein the metasurface structure comprises a substrate with a conductive pattern disposed on the substrate.
